(19) United States
(12) Patent Application Publication
(10) Pub. No.: US 2004/0031911 A1
(43) Pub. Date: Feb. 19, 2004

(54) Device with an electromagnetic actuator

(76) Inventors: Frank Hoffmann, Fellbach (DE); Robert Schmidt, Fellbach (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/446,143

(22) Filed: May 28, 2003

(30) Foreign Application Priority Data
May 29, 2002 (DE) 102 23 870.7

(51) Int. Cl. G01J 5/08

(52) U.S. Cl. 250/227.19

(57) ABSTRACT

A device having an electromagnetic actuator for actuating a control element, in particular a charge cycle valve of an internal combustion engine. The actuator includes at least one elastic element, for example, a valve spring, provided for the purpose of elastic deformation. The elastic element is connected to a deformation sensor providing a signal making it possible to determine the deformation of the elastic element, and to determine the position of the control element.

### BACKGROUND AND SUMMARY OF THE INVENTION

This application claims the priority of German Priority document 102 23 870.7, filed May 29, 2002, the disclosure of which is expressly incorporated by reference herein.

The invention relates to an electromagnetic actuator.

An electromagnetic actuator, in particular for actuating a charge cycle valve of an internal combustion engine, generally has two switching magnets. There is an opening magnet and a closing magnet, between whose pole faces an actuating element is moveably mounted. Such an actuating element is, for example, an armature, arranged so as to be coaxially displaceable with respect to a valve axis, of a charge cycle valve, or a rotatably mounted pivoting armature. In actuators according to the principle of the mass oscillator, a prestressed spring mechanism acts on the actuating element, for example the armature. Two prestressed springs usually serve as the spring mechanism, one of the springs loading the charge cycle valve in the opening direction and the other loading the charge cycle valve in the closing direction. When the magnets are not excited, the actuating element is held in a position of equilibrium between the magnets by the valve springs.

In order to actuate the control element, for example an outlet valve of an internal combustion engine, which is connected to the actuating element, the magnets must be capable of applying high forces, in particular when the outlet valve opens. The respective end position of the valve must always be reliably reached in such cases when the valve opens and closes. In order to monitor the valve, it is advantageous to know the respective position of the valve precisely. In addition, variables which are not taken into account from the beginning and which vary over time and/or during the operation lead to a situation in which, for example, the position of equilibrium of an armature which is determined by the valve springs does not coincide with an energetic central position between the pole faces, and the actuation of the valve is thus adversely affected. Such changing variables are, for example, fabrication tolerances of individual components, thermal expansion of different materials, different spring stiffnesses of the two valve springs or else ageing and wear of individual components.

German reference DE 197 35 375 C1 discloses a solenoid valve in which the position of the armature is determined from pressure measurements using piezo-measuring elements under the spring foot points.

The present invention provides a device having an actuator for actuating a control element, in which device, the position of the control element during the operation of the actuator can be sensed as precisely as possible and over a large range.

The invention is based on a device having an electromagnetic actuator for actuating a control element, in particular a charge cycle valve of an internal combustion engine, the actuator including at least one elastic element provided for the purpose of elastic deformation with the elastic element being connected to a deformation sensor.

It is possible to use, for example, a spring or some other object which deforms elastically during the actuation of the control element as the elastic element. Such an elastic element is indirectly or directly operatively connected to the control element and changes its spatial shape when the control element is actuated. As a result, at least one of its outer faces and also an inner region of the control element is subjected to extension or compression. A deformation sensor is understood to be a sensor whose output signal is influenced by the extension or compression of an elastic element which is assigned to the sensor. This influencing process can take place optically, for example by optical analysis of the elastic element, electrically or mechanically, for example by means of a deformation of the elastic element. In the case of a mechanical influencing process, the deformation sensor is expediently permanently connected to the surface or to the interior of the elastic element. The fixed connection between the deformation sensor and the elastic element can be brought about by means of a materially joined connection, for example bonding. It can equally well be manufactured by means of a positively locking or a frictionally locking connection. The important factor for such a connection is that the mechanical deformation, for example a spatial compression or extension, is transmitted mechanically to the deformation sensor.

On the basis of the measurement of the deformation of the elastic element, it is possible to form reliable conclusions about the position of the control element. Such a measurement is largely independent of external circumstances such as temperature, soiling or electromagnetic fields and is not influenced either by ageing or wear phenomena of the electromagnetic actuator or of its components. The position of the control element which is determined using the deformation sensor can be used to control and regulate the actuator.

In an advantageous refinement of the invention, the deformation sensor is a strain gauge. A strain gauge includes an electrical conductor which is mounted on a carrier, for example a film, and whose electrical resistance changes when the conductor deforms. It is possible to use a commercially available strain gauge, for example a metal strain gauge or a semiconductor strain gauge. The strain gauge is permanently applied to the surface of the elastic element so that it is compressed or extended when the elastic element is deformed. As a result, the electrical resistance of the conductor changes. The electrical resistance is thus a measure of the deformation of the elastic element and therefore also of the position of the control element. The strain gauge is, for example, bonded to the surface of the elastic element, and may be covered with a protective layer in order to protect it against external influences. The strain gauge can, however, also be integrated into an elastic element which is of multi-layer construction, for example. The precision of a deformation sensor which is configured in such a way is very high, while the mass of the sensor which is to be additionally moved with the control element is very small. Using a strain gauge as a deformation sensor, it is possible to determine the position of the control element very precisely and largely independently of external influences. In addition, a strain gauge is particularly simple to handle and economical to acquire.

In one preferred refinement of the invention, the deformation sensor is a Bragg grating sensor. A Bragg grating sensor is an optical fiber measuring sensor which includes a light guide, for example a glass fiber, in which a number of reflection planes which are arranged equidistantly in the axial direction have been produced. In order to measure the deformation using a Bragg grating sensor, laser light of a relatively wide wavelength range is injected into the light guide. The light which is reflected at the reflection planes, causes structural interference if the wavelength corresponds to twice the distance between the reflection planes, or to a multiple thereof. If the part of the light guide in which the reflection planes—the Bragg grating—are located is extended or compressed, the grating spacing changes. The structurally reflected wavelength is thus displaced. It is thus possible to use the displacement of the wavelength of the reflected light to draw conclusions about the change in the grating spacing and thus about the change in length of the light guide. If the Bragg grating sensor is permanently connected to the elastic element, it is extended or compressed along with the deformation of the elastic element. As a result, the grating spacing of the reflection planes is displaced. On the basis of the displacement of the wavelength of the reflected light, it is possible to determine the change in length of the part of the elastic element on which the glass fiber is mounted. By determining the relationship between a position of the control element and a deformation of the elastic element, it is possible to determine the position of the control element extremely quickly and accurately using the Bragg grating sensor. A Bragg grating sensor is also defined by the fact that it is insensitive to electromagnetic influences and that absolute values of the change in length can be interrogated at any time after the installation of the sensor by injecting light with a suitable wavelength range and subjecting the reflected light to spectral analysis. Furthermore, a Bragg grating sensor does not require any extensive electrical connections, which makes it particularly reliable even in an environment which is particularly subject to mechanical, chemical or electromagnetic stress. Furthermore, it is possible to use a Bragg grating sensor to precisely measure, thus permitting the position of the control element to be determined very precisely.

Bragg grating sensor can be mounted either on the surface of the elastic element, which is particularly simple, or be integrated into the elastic element itself. By introducing it into the elastic element, the Bragg grating sensor is particularly protected against external mechanical effects. Such an arrangement is particularly advantageous if the elastic element itself includes fibers in its structure, for example carbon fibers or glass fibers, or both, bound in a resin. The light guide of the Bragg grating sensor can then be easily integrated into the elastic element so that it is extremely durable and very reliable and supplies very precise measured values independently of external influences.

A plurality of deformation sensors are expediently connected to the elastic element. By attaching or assigning a plurality of deformation sensors to the elastic element, it is possible to determine the position of the control element very accurately and reliably. However, it is also possible to attach a plurality of deformation sensors to a plurality of elastic elements of the device. In this way, in each case one or more deformation sensors is expediently arranged on both springs of a charge cycle valve of an internal combustion engine. With such an arrangement it is possible to determine the position of the control element very precisely and also very reliably even if one of the sensors fails. The light guide can be configured in such a way that it contains two or even more Bragg grating sensors along its length. A Bragg grating sensor thus includes two or more light guide sections, each with a number of equidistantly formed reflection planes. It is possible to position a plurality of sensors in a light guide, and thus monitor the elastic element at a plurality of points, without a large degree of structural expenditure. It is particularly advantageous here to arrange a number of Bragg grating sensors with different characteristic frequencies in the light guide. The characteristic frequency of a Bragg grating sensor is the frequency of the reflected light in a mechanically uninfluenced state of the light guide. Each Bragg grating sensor reflects light with a frequency which—due to the deformation—fluctuates slightly about the characteristic frequency which is assigned to the respective sensor. If different sensors have different characteristic frequencies, that is to say a different reflection plane spacing, it is possible to determine, on the basis of the frequency of the reflected light, which Bragg grating sensor reflects the light. As a result, both the spatial location of the deformation and the degree of the deformation can be determined precisely.

The elastic element is preferably part of a spring mechanism of the actuator. The spring mechanism of the actuator experiences particularly large deflection when the control element is actuated. As a result, it is possible to measure the position of the control element precisely.

The elastic element can expediently be a helical compression spring or, in an alternative refinement, a torsion spring. The deflection of the springs, and thus their measurable deformation, is dependent, and possibly even proportional, to the deflection of, for example, a charge cycle valve. By means of the measurement signal of the deformation sensor, it is thus possible easily to draw conclusions about the deformation of the spring, and in turn about the position of the valve on the basis of the deformation. Such an arrangement permits precise, reliable and particularly easy-to-handle measurement of the position of the valve.

An evaluation unit for determining the deformation of the elastic element is expediently connected to the deformation sensor. This evaluation unit, for example a semiconductor module, is advantageously also simultaneously provided for determining the position of the control element on the basis of the deformation of the elastic element. This permits essentially continuous determination of the deformation or of the position of the control element.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a longitudinal section through a schematically illustrated actuator, and

FIG. 2 shows an enlarged detail of the actuator.

### DETAILED DESCRIPTION OF THE PREFERRED EMBODIMENTS

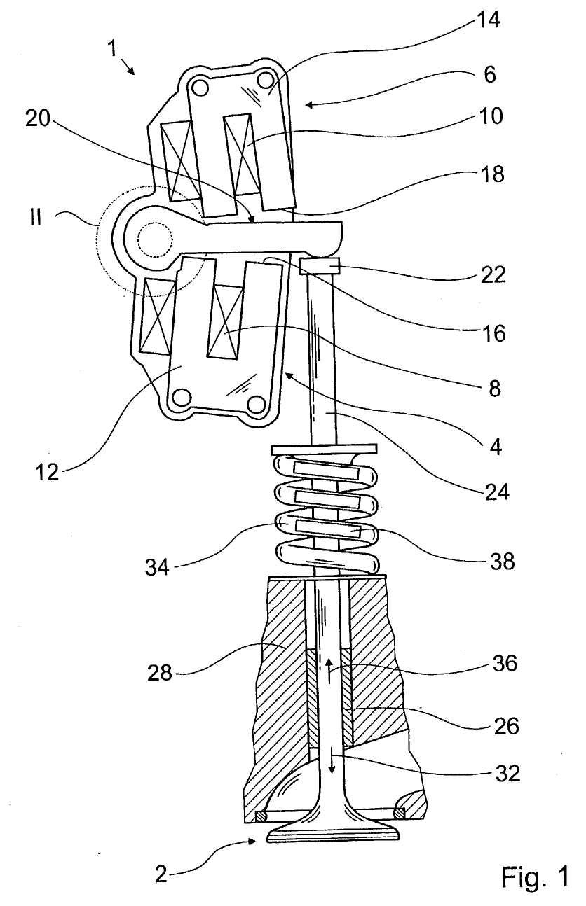

FIG. 1 shows a longitudinal section through a schematically illustrated actuator 1 for actuating a charge cycle valve 2 of an internal combustion engine (not illustrated in more detail). The actuator 1 has an electromagnetic unit with two electromagnets 4, 6, an opening magnet 4 and a closing magnet 6. Each of the electromagnets 4, 6 has a solenoid 8, 10 which is wound onto a coil former (not illustrated in more detail), and a coil core 12, 14 with two yoke limbs which form pole faces 16, 18 with their end sides. Between the pole faces 16, 18 a pivoting armature 20 is mounted so as to be capable of pivoting to and fro about an axis. The pivoting armature 20 acts on the charge cycle valve 2 via a play-compensating element 22 and via a valve stem 24. The valve stem 24 is mounted in an axially displaceable fashion in a cylinder head 28 of the internal combustion engine by means of a stem guide 26.

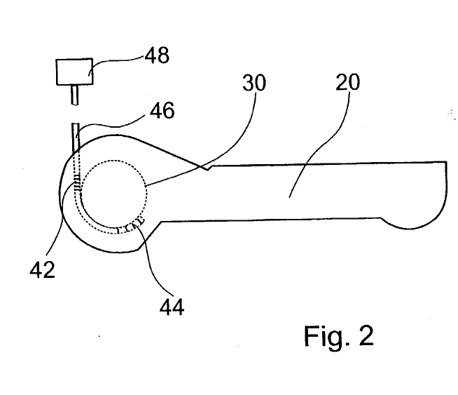

The actuator 1 also comprises a spring mechanism with two prestressed valve springs, specifically with a valve spring which is formed as a torsion spring 30 (see FIG. 2) and acts in the opening direction 32, and with a valve spring which is formed as a helical compression spring 34 and acts in the closing direction 36.

In the closed position of the charge cycle valve 2, the pivoting armature 20 bears against the pole face 18 of the excited closing magnet 6 and is held by it. The closing magnet 6 further prestresses the torsion spring 30 which acts in the opening direction 32. In order to open the charge cycle valve 2, the closing magnet 6 is switched off and the opening magnet 8 is switched on. The torsion spring 30 which acts in the opening direction 32 accelerates the pivoting armature 20 beyond the position of equilibrium so that said pivoting armature 20 is attracted by the opening magnet 8. The pivoting armature 20 strikes against the pole face 16 of the opening magnet 8 and is held tight by it. In order to close the charge cycle valve 2 again, the opening magnet 8 is switched off and the closing magnet 6 switched on. The helical compression spring 34 which acts in the closing direction 36 accelerates the pivoting armature 20 beyond the position of equilibrium to the closing magnet 6. The pivoting armature 20 is attracted by the closing magnet 6, strikes against the pole face 18 of the closing magnet 6 and is held tight by it.

Three deformation sensors 38 are mounted on the helical compression spring 34. These deformation sensors 38 are strain gauges. The strain gauges 38 are permanently bonded to the surface of the helical compression spring 34 so that they are permanently connected to the surface. The three deformation sensors 38 are each coated with a protective layer (not illustrated in more detail) to protect them against external effects.

During an opening process of the charge cycle valve 2, the helical compression spring 34 is pressed together and the three deformation sensors 38 are each simultaneously deformed. During a closing process of the charge cycle valve 2, the helical compression spring 34 relaxes in the closing direction 36, the deformation sensors 38 being in turn slightly deformed. The deformation sensors 38 have an electrical conductor with an electrical resistance. Depending on the geometric position of the electrical conductor on the strain gauge, the electrical resistance becomes larger or smaller in one direction or the other when the strain gauge is deformed. On the basis of a resistance value of each of the strain gauges, it is thus possible to determine deformation of the helical compression spring 34 and the position of the charge cycle valve 2 on the basis of said deformation.

The deformation sensors 38 are electrically connected to an evaluation unit (not shown in more detail in the figure) for determining the deformation of the helical compression spring 34. This evaluation unit is also provided for determining the position of the charge cycle valve 2 on the basis of the deformation of the helical compression spring 34.

When the charge cycle valve 2 moves in the opening direction 32 or closing direction 36, not only the helical compression spring 34 but also the torsion spring 30 is deformed. This deformation is sensed by two deformation sensors 42, 44 (shown in FIG. 2) which are configured as Bragg grating sensors. They each comprise reflection planes which are arranged equidistantly in a light guide 46. The light guide 46 and the Bragg grating sensors are shown schematically in a basic view. During an opening or closing process of the charge cycle valve 2, the torsion spring 30 is deformed in each case through torsion. The light guide 46, which is arranged pre-extended on the torsion spring 30, is extended to a greater or lesser degree when the torsion spring 30 is subject to torsion. As a result, the reflection planes of the deformation sensor 42 are extended. The light guide 46 is permanently bonded to the torsion spring 30 at the location on the light guide 46 where the deformation sensor 44 is arranged. The light guide 46 does not extend perpendicularly with respect to the axial direction of the torsion spring 30 at this location so that the deformation sensor 44 is extended or compressed when the torsion spring is subjected to torsion.

While the actuator 1 is operating, laser light with a relatively wide wavelength range is injected into the light guide 46 by a laser which is integrated into an evaluation unit 48. This light is, in each case, partially reflected by the deformation sensors 42, 44. The wavelength of the reflected laser light is twice a plane spacing or a multiple thereof. If the light guide 46 is extended, and the deformation sensors 42, 44 along with it, the spacing between the equidistant reflection planes in the light guide 46 increases. As a result, the wavelength of the reflected light also becomes longer. The reflected laser light is subjected to spectral analysis by the evaluation unit 48. A wavelength which is determined by the evaluation unit 48 is processed to form an output signal which is fed to a further evaluation and control unit which is not illustrated in more detail in the figure. This unit processes the output signal to form a further signal which corresponds to the position of the charge cycle valve 2 and is used to control the actuator 1.

The light guide 46 comprises two deformation sensors 42, 44 whose equidistantly arranged reflection planes each have a different plane spacing. The laser light which is injected in broadband form is reflected both by the deformation sensor 42 and the deformation sensor 44 with the respective characteristic frequency. On the basis of the frequency of the reflected laser light, the evaluation unit 48 determines from which of the two deformation sensors 42, 44 the reflected light originates. On the basis of the displacement of the wavelength of the reflected light which results from the deformation, the deformation of the torsion spring 30 can thus be determined at any location at which one of the deformation sensors 42, 44 is situated.

Using both the deformation sensor 38 and the deformation sensors 42, 44, it is possible to determine the position of the charge cycle valve 2 very easily and very precisely as well as also very reliably. The deformation sensors 38, 42, 44 are insensitive to mechanical and thermal loading and are also suitable for mutual monitoring. The position of the charge cycle valve 2 which is determined using the deformation sensors 38, 42, 44 is used to control and regulate the actuator 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An electromagnetic actuator device for actuating a control element, the actuator device comprising:
at least one elastic element provided for the purpose of elastic deformation; and
at least one deformation sensor each connected to one of said at least one elastic element.

2. The device according to claim 1, wherein the at least one deformation sensor is a strain gauge.

3. The device according to claim 1, wherein the at least one deformation sensor is a Bragg grating sensor.

4. The device according to claim 1, wherein said at least one deformation sensor is a plurality of deformation sensors.

5. The device according to claim 3, wherein the elastic element is part of a spring mechanism of the actuator device.

6. The device according to claim 1, wherein the elastic element is part of a spring mechanism of the actuator device.

7. The device according to claim 1, wherein the elastic element is a helical compression spring.

8. The device according to claim 1, wherein the elastic element is a torsion spring.

9. The device according to claim 1, further comprises an evaluation unit connected to the at least one deformation sensor for sensing the deformation of the elastic element.

10. The device according to claim 9, wherein the evaluation unit is provided for determining the position of the control element from the deformation of the elastic element.

11. The device according to claim 1, wherein said control element is a charge cycle valve of an internal combustion engine.

12. The device according to claim 1, wherein said at least one elastic element includes one of a strain gauge and a Bragg grating sensor and wherein said at least one deformation element includes a torsion spring connected to said Bragg grating sensor and a compression spring connected to said strain gauge.

13. The device according to claim 2, wherein the elastic element is part of a spring mechanism of the actuator device.

14. The device according to claim 3, wherein the elastic element is part of a spring mechanism of the actuator device.

15. The device according to claim 2, wherein the elastic element is a helical compression spring.

16. The device according to claim 3, wherein the elastic element is a helical compression spring.

17. The device according to claim 2, wherein the elastic element is a torsion spring.

18. The device according to claim 3, wherein the elastic element is a torsion spring.

19. The device according to claim 2, further comprises an evaluation unit connected to the at least one deformation sensor for sensing the deformation of the elastic element.

20. The device according to claim 3, further comprises an evaluation unit connected to the at least one deformation sensor for sensing the deformation of the elastic element.
